(19) United States
(12) Patent Application Publication
(10) Pub. No.: US 2011/0076602 A1
(43) Pub. Date: Mar. 31, 2011

(54) ELECTROPHOTOGRAPHIC PHOTOCONDUCTOR AND IMAGE FORMING APPARATUS INCLUDING THE SAME

(76) Inventors: Kotaro FUKUSHIMA, Osaka (JP); Mami Adachi, Osaka (JP)

(21) Appl. No.: 12/888,646

(22) Filed: Sep. 23, 2010

(30) Foreign Application Priority Data
Sep. 25, 2009 (JP) 2009-220982

(51) Int. Cl. G03G 15/00

(52) U.S. Cl. 430/56; 399/159; 430/58.75

(57) ABSTRACT

An electrophotographic photoconductor that is usable in an exposure light source having a wavelength of 405±20 nm, the electrophotographic photoconductor comprising a photosensitive layer including a charge generation layer and a charge transfer layer stacked in order on a conductive substrate,
the charge transfer layer containing, as a charge transfer material, a phenylenediamine compound represented by the following general formula (I):

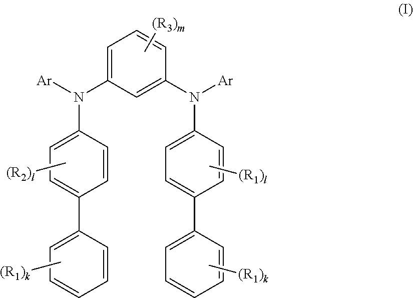

wherein Ar is an aryl group that may have a substituent, R₁, R₂ and R₃ are a hydrogen atom, a halogen atom, or an alkyl or alkoxy group, independently, R₃ is a hydrogen atom, a halogen atom, or an alkyl or alkoxy group that may have a substituent, k is an integer from 1 to 5, and l and m are an integer from 1 to 4,
the charge generation layer containing, as a charge generation material, a titanylphthalocyanine having a crystal form showing diffraction peaks in an X-ray diffraction spectrum at Bragg angles (2θ±0.2°) of 7.5°, 12.3°, 16.3°, 25.3° and 28.7°.

### CROSS-REFERENCE TO RELATED APPLICATION

This application is related to Japanese Patent Application No. 2009-220982 filed on 25 Sep., 2009, whose priority is claimed under 35 USC §119, and the disclosure of which is incorporated by reference in its entirety.

### BACKGROUND OF THE INVENTION

1. Field of the Invention

The present invention relates to an electrophotographic photoconductor and an image forming apparatus including the same to be used for high-definition image formation of an electrophotographic system.

More specifically, the present invention relates to an electrophotographic photoconductor using a specific phenylenediamine as a charge transfer material and a titanylphthalocyanine having a specific crystal form as a charge generation material, and an image forming apparatus including the photoconductor.

2. Description of the Related Art

Organic photoconductors using an organic photoconductive material (Organic Photoconductor, abbreviated as OPC) have some problems in sensitivity, durability and stability to an environment. However, they have many advantages in terms of toxicity, manufacturing cost and degrees of freedom in material design compared with inorganic photoconductors.

Furthermore, the organic photoconductors are advantageous in that their photosensitive layers can be formed by an easy and inexpensive method represented by a dipping coating method.

The organic photoconductors have been gradually becoming the mainstream of electrophotographic photoconductors as having many advantages in terms of production as described above.

In addition, since recent research and development have improved the sensitivity and the durability of the organic photoconductors, the organic photoconductors have recently come to be used as electrophotographic photoconductors except for special cases.

In particular, the performance of the organic photoconductors has been significantly improved by development of function-separating type photoconductors in which a charge generation function and a charge transfer function are assigned to separate materials, respectively.

That is, in addition to the advantages of the organic photoconductors, the function-separating type photoconductors have an advantage in that they have a wide range of choices for materials for forming their photosensitive layers and photoconductors having optional characteristics can be produced relatively easily.

As structures of such organic photoconductors, there have been proposed various structures such as a layered structure and an inverse double-layered structure in which a charge generation layer obtained by dispersing a charge generation material in a binder resin and a charge transfer layer obtained by dispersing a charge transfer material in a binder resin are formed on a conductive substrate in this order or an order inverse thereto.

Out of these photoconductors, function-separating type photoconductors having, as a photosensitive layer, a charge generation layer and a charge transfer layer stacked on the charge generation layer have been in a practical use widely, because they are excellent in electrophotographic characteristics and durability, and allow design variation for characteristics of the photoconductors as having a higher degree of freedom of material selection.

Meanwhile, laser printers are a representative example of electrophotographic devices using a laser beam as an exposure light source. In recent years, however, digitization has progressed and use of a laser beam as an exposure light source has been common also in copying machines. For laser beams to be mainly used as an exposure light source, semiconductor lasers, which are low-cost, low-energy-consuming, lightweight and small-sized have been put to practical use, and they generally have an oscillation wavelength in a near-infrared region around 800 nm for the sake of lifetime and stability in oscillation wavelength and output.

This is because laser beams that oscillate at a shorter wavelength have been incomplete for practical use due to some technical problems. In response to this, a multilayer photoconductor has been developed in which a charge generation layer contains an organic compound that absorbs light and has sensitivity in a long wavelength region, in particular, a phthalocyanine pigment as a charge generation material to be used in an electrophotographic device using a laser beam as an exposure light source (Japanese Examined Patent Publication No. HEI 6(1994)-29975), and a charge transfer layer contains a triphenylamine compound (Japanese Examined Patent Publication NO. SHO 58(1983)-32372, Japanese Unexamined Patent Publication No. HEI 2(1990)-190862), a stilbene compound (Japanese Unexamined Patent Publication No. SHO 54(1979)-151955, Japanese Unexamined Patent Publication No. SHO 58(1983)-198043), a hydrazone compound (Japanese Unexamined Patent Publication No. SHO 54(1979)-150128, Japanese Examined Patent Publication NO. SHO 55(1980)-42380, Japanese Unexamined Patent Publication No. SHO 55(1980)-52063), a phenylenediamine compound (Japanese Unexamined Patent Publication No. HEI 3(1991)-1155, Japanese Unexamined Patent Publication No. HEI 4(1992)-291266) or an enamine compound (Japanese Unexamined Patent Publication No. HEI 7(1995)-134430).

A method for producing a blue light emitting diode was invented in 1990 (Japanese Patent No. 2628404), and since then development of arts related to blue semiconductor lasers has been promoted actively and a next-generation disk called Blu-ray disc has been spreading rapidly.

At the same time, in recent years, it has been considered to attain higher resolution for image quality to aim at improvement in quality of images output from electrophotographic devices. Examples of a measure for attaining high-resolution image quality with a higher recording density include an optical method in which the spot diameter of a laser beam is narrowed to increase the writing density. Then, it is necessary to shorten the focal distance of the lens to use. However, designing of such an optical system is difficult and besides it is difficult to obtain clear spot outline with a laser beam having an oscillation wavelength in a near-infrared region around 800 nm even if the diameter of the laser beam is narrowed by operation of the optical system. The cause lies in the diffraction limit of the laser beam, which is an unavoidable phenomenon.

Generally, the spot diameter D of a laser beam converged onto a surface of a photoconductor and the wavelength of the laser beam and the numerical aperture NA of the lens are in a relationship represented by the following formula:

D=1.22λ/NA

wherein λ is a wavelength of the laser beam, NA is a numerical aperture of the lens.

This formula suggests that the spot diameter D is in proportion to the oscillation wavelength of the laser beam, and it is necessary to use a laser beam having a shorter oscillation wavelength in order to narrow the spot diameter D.

That is, it is indicated that use of a blue semiconductor laser instead of a currently mainstream near-infrared semiconductor laser allows achievement of a still higher resolution.

However, such a blue laser beam was hardly expected to work as an exposure light source in electrophotographic devices, though it made a great contribution to the purpose of improving the recording density of optical disks. That is because conventional electrophotographic photoconductors did not have sensitivity in the above-mentioned wavelength region.

As conventional multilayer electrophotographic photoconductors, those including a charge generation layer and a charge transfer layer stacked in order on a conductive substrate are generally in use. In theory, use of a charge generation material that has absorption also at a wavelength of 425 nm or less should lead to achievement of photoconductors generally showing sensitivity to exposure by a short-wavelength laser beam of 425 nm or less.

In fact, however, multilayer electrophotographic photoconductors do not show sensitivity to this wavelength region, because a charge transfer layer stacked on a charge generation layer, in particular, a charge transfer material has absorption at a wavelength of 425 nm and a short-wavelength laser beam used as an exposure light source is therefore absorbed in a surface of a photosensitive layer to be prevented from reaching the charge generation layer.

In addition, there has been another problem; charge transfer and charge generation materials are likely to change in quality due to exposure with high-intensity light of a unified wavelength component to reduce sensitivity of a photoconductor and prevent maintenance of high image quality with long-term use.

An electrophotographic photoconductor that deals with these problems has been developed (Japanese Patent No. 3937602), but no photoconductors have achieved a good balance between film transmittance and high sensitivity. In addition, there has been another problem; a charge transfer material that does not have absorption at a wavelength of 425 nm or less prevents smooth injection of charges from a charge generation material to produce a photoconductor having sensitivity that will deteriorate to a great extent with repeated use.

Furthermore, there has been another problem; image defects such as fogging are likely to occur in the case of exposure with light of 405±20 nm, in which the charging level is significantly reduced under a low-humidity circumstance.

It is an object of the present invention to provide an electrophotographic photoconductor for high-definition printing having high sensitivity in a wavelength region of 405±20 nm, excellent environmental stability and stable characteristics even with repeated use.

Furthermore, it is another object of the present invention to provide an electrophotographic device having high stability, high sensitivity and high resolution by using the present photoconductor and a semiconductor laser having an oscillation wavelength in a range of 405±20 nm.

### SUMMARY OF THE INVENTION

The inventors of the present invention have made intensive studies and efforts and, as a result, found that it is possible to provide an electrophotographic photoconductor that can be used with an exposure light source having a wavelength of 405±20 nm and that has high stability, high sensitivity and high resolution by using a specific phenylenediamine compound as a charge transfer material and using a titanylphthalocyanine having a specific crystal structure as a charge generation material, to complete the present invention.

In accordance with an aspect of the present invention, therefore, there is provided an electrophotographic photoconductor that is usable in an exposure light source having a wavelength of 405±20 nm, the electrophotographic photoconductor comprising a photosensitive layer including a charge generation layer and a charge transfer layer stacked in order on a conductive substrate,

the charge transfer layer containing, as a charge transfer material, a phenylenediamine compound represented by the following general formula (I):

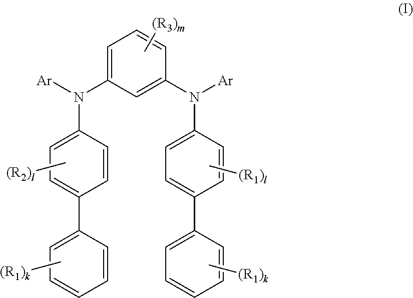

wherein Ar is an aryl group that may have a substituent, R₁, R₂ and R₃ are a hydrogen atom, a halogen atom, or an alkyl or alkoxy group, independently, R₃ is a hydrogen atom, a halogen atom, or an alkyl or alkoxy group that may have a substituent, k is an integer from 1 to 5, and l and m are an integer from 1 to 4,

the charge generation layer containing, as a charge generation material, a titanylphthalocyanine having a crystal form showing diffraction peaks in an X-ray diffraction spectrum at Bragg angles (2θ±0.2°) of 7.5°, 12.3°, 16.3°, 25.3° and 28.7°.

In accordance with another aspect of the present invention, there is provided an image forming apparatus comprising: an electrophotographic photoconductor that is used with an exposure light source having a wavelength of 405±20 nm; a charge means for charging the electrophotographic photoconductor; an exposure means for exposing the charged electrophotographic photoconductor with the light source having a wavelength of 405±20 nm; and a development means for developing an electrostatic latent image to be formed by exposure, the electrophotographic photoconductor comprising at least a charge generation layer and a charge transfer layer stacked in order on a conductive substrate, the charge transfer layer containing, as a charge transfer material, a phenylenediamine compound represented by the following general formula (I):

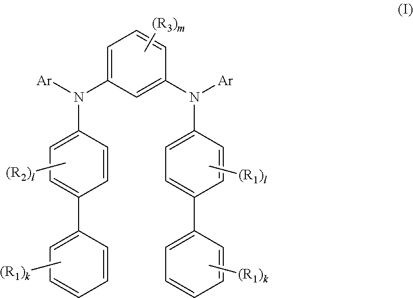

wherein Ar is an aryl group that may have a substituent, R₁, R₂ and R₃ are a hydrogen atom, a halogen atom, or an alkyl or alkoxy group, independently, R₃ is a hydrogen atom, a halogen atom, or an alkyl or alkoxy group that may have a substituent, k is an integer from 1 to 5, and l and m are an integer from 1 to 4, the charge generation layer containing, as a charge generation material, a titanylphthalocyanine having a crystal form showing diffraction peaks in an X-ray diffraction spectrum at Bragg angles (2θ±0.2°) of 7.5°, 12.3°, 16.3°, 25.3° and 28.7°.

It is possible to provide an electrophotographic photoconductor and an electrophotographic device having high stability even under a low-humidity circumstance, high sensitivity and high resolution by including the phenylenediamine compound represented by the general formula (I) as a charge transfer material and including the titanylphthalocyanine having a crystal form showing diffraction peaks in an X-ray diffraction spectrum at Bragg angles (2θ±0.2°) of 7.5°, 12.3°, 16.3°, 25.3° and 28.7° as a charge generation material in an electrophotographic photoconductor that is used with an exposure light source having a wavelength of 405±20 nm.

In accordance with still another aspect of the present invention, there is provided an electrophotographic device comprising: the above-described electrophotographic photoconductor; a charge means for charging the electrophotographic photoconductor; an exposure means for exposing the charged electrophotographic photoconductor with a blue semiconductor laser; and a development means for developing an electrostatic latent image to be formed by exposure.

### BRIEF DESCRIPTION OF THE DRAWINGS

FIG. 1 is a schematic sectional view illustrating a structure of a multilayer photoconductor of the present invention;

FIG. 2 is an X-ray diffraction spectrum of a titanylphthalocyanine that can be used for the present invention;

FIG. 3 is a transmission and absorption spectrum of a charge generation layer using the titanylphthalocyanine that can be used for the present invention;

FIG. 4 is a schematic sectional view illustrating another structure of the multilayer photoconductor of the present invention; and

FIG. 5 is a schematic side view illustrating a structure of an image forming apparatus of the present invention.

### DESCRIPTION OF THE PREFERRED EMBODIMENTS

In the present invention, in the general formula (I), the aryl group represented by Ar is preferably a phenyl, naphthyl or biphenyl group; the substituent that the aryl group may have is a C₁₋₄ alkyl or alkoxy group; the halogen atom represented by R₁, R₂ and R₃ is a fluorine, chlorine, bromine or iodine atom; and the alkyl or alkoxy group represented by R₁, R₂ and R₃ are a C₁₋₄ alkyl or alkoxy group.

Specifically, in the present invention, Ar in the general formula (I) is preferably 3-methylphenyl, 4-methylphenyl, 3,4-dimethylphenyl, 3,5-dimethylphenyl, 3-ethylphenyl, 4-ethylphenyl, 3,4-diethylphenyl, 3,5-diethylphenyl, 3-methoxyphenyl, 4-methoxyphenyl, 3,4-dimethoxyphenyl, 3,5-dimethoxyphenyl, 3-ethoxyphenyl, 4-ethoxyphenyl, 3,4-diethoxyphenyl, 3,5-diethoxyphenyl, 1-naphthyl, 2-naphthyl, 2′-methyl-4-biphenylyl, 4′-methyl-4-biphenylyl, 2′,4′-dimethyl-4-biphenylyl group, 2′-methyl-4-biphenylyl, 4′-ethyl-4-biphenylyl or 2′,4′-diethyl-4-biphenylyl group;

R₁ is a hydrogen atom, or a 2′-, 3′-, 4′-, 5′- or 6′-methyl or ethyl group, R₂ is a hydrogen atom, or a 2-, 3-, 5- or 6-methyl or ethyl group, and R₃ is a hydrogen atom, or a 2-, 4-, 5- or 6-methyl or ethyl group.

More specifically, in the present invention, the compound of the general formula (I) contains hydrogen atoms as R₂ and R₃, and is a phenylenediamine compound represented by the general formula (II):

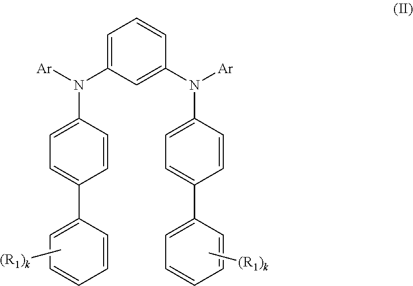

wherein Ar, R₁ and k are as defined in the general formula (I).

Further specifically, in the present invention, the compound of the general formula (I) contains a 4-methylphenyl or 2′-methyl-4-biphenylyl group as Ar, a hydrogen atom or a 2′-methyl group as R₁, and hydrogen atoms as R₂ and R₃, and is a phenylenediamine compound represented by the following formulae:

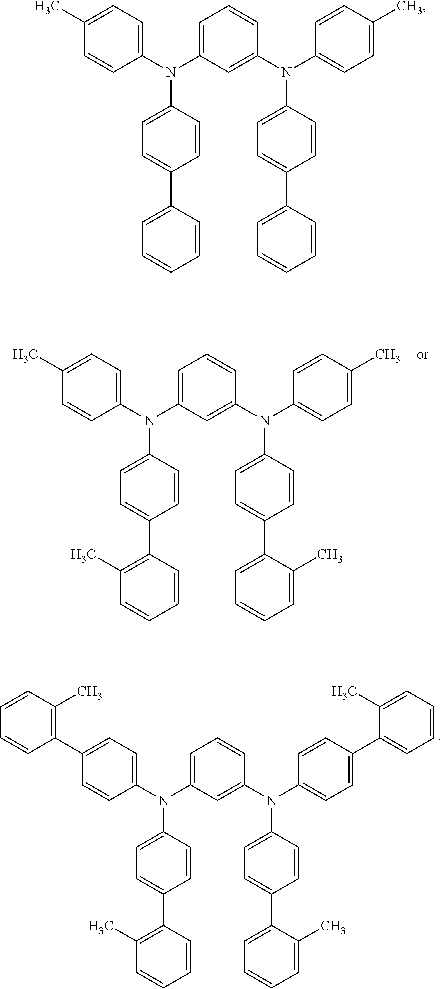

General charge transfer materials achieve high mobility of charges by expanding their electron clouds as much as possible in their structures.

However, expansion of electron clouds tends to make the absorption wavelength of the charge transfer materials longer. While the phenylenediamine compound of the present invention keeps the expansion of its electron cloud to a relatively small extent, it has a certain degree of mobility of charges that is sufficient for practical use.

That is, the phenylenediamine compound of the present invention has a structure that achieves an absolutely excellent balance between the absorbance for the exposure light source in a wavelength range of 405±20 nm and the mobility. Inclusion of the phenylenediamine compound of the present invention in the charge transfer layer therefore leads to satisfactory transmissivity for the exposure light source in the wavelength range of 405±20 nm and satisfactory electrical characteristics.

In accordance with an aspect of the present invention, therefore, there is provided an electrophotographic photoconductor having high stability even with repeated use under a low-humidity circumstance, high sensitivity and high resolution, and an image forming apparatus including the photoconductor by including, as a charge transfer material, the phenylenediamine compound of the present invention in the charge transfer layer and including, as a charge generation material, a titanylphthalocyanine having a crystal form showing diffraction peaks in an X-ray diffraction spectrum at Bragg angles (2θ±0.2°) of 7.5°, 12.3°, 16.3°, 25.3° and 28.7°.

This is considered because the titanylphthalocyanine as the charge generation material used in the present invention can generate charges efficiently when exposed with a laser beam of 405±20 nm and inject the generated charges into the phenylenediamine compound as the charge transfer material of the present invention smoothly to allow the compound to transfer the charges efficiently.

That is, the present invention has a specifically good matching relationship between the charge generation material and the charge transfer material.

In addition, in accordance with an aspect of the present invention, there is provided an image forming apparatus in which the exposure means is a blue-violet semiconductor laser.

Next, materials that are generally used for electrophotographic photoconductors will be described. However, the photoconductor materials according to the present invention are not limited to those described below.

FIG. 1 is a schematic cross sectional view simplistically illustrating a structure of an electrophotographic photoconductor 1 as an example of the electrophotographic photoconductor of the present invention.

The electrophotographic photoconductor 1 is a multilayer photoconductor having an interlayer 18 provided on a sheet-like conductive support 11 formed of a conductive material; and thereon a photosensitive layer 14 of a layered structure in which a charge generation layer 15 containing a charge generation material 12, and a charge transfer layer 16 containing a charge transfer material 13 and a binder resin 17 for binding the charge transfer material 13 are stacked in this order outward from the conductive support 11.

### Conductive Support

Examples of the conductive material that forms the conductive support 11 include metallic materials such as aluminum, aluminum alloy, copper, zinc, stainless steel and titanium; and materials obtained by laminating a metallic foil, vapor-depositing a metallic material, or vapor-depositing or applying a layer of a conductive compound such as conductive polymer, tin oxide and indium oxide on a surface of a polymeric material such as polyethylene terephthalate, nylon and polystyrene, or hard paper, glass, or the like. In particular, aluminum alloys of JIS3003, JIS5000 and JIS6000 are preferably used.

The shape of the conductive support 11 may be sheet-like, drum-like, endless belt-like, or the like.

As needed, the surface of the conductive support 11 may be processed by anodic oxidation coating treatment, surface treatment using chemicals or hot water, coloring treatment or irregular reflection treatment such as surface roughing to the extent that the image quality is not adversely affected. In an electrophotographic process using a laser beam as an exposure light source, the wavelength of the laser beam is unified to cause interference between the incident laser beam and the light reflected in the electrophotographic photoconductor, and interference fringes due to the interference may appear on an image to cause an image defect.

Such an image defect due to the interference by the laser beam having a unified wavelength can be prevented by processing the surface of the conductive support 11 as described above.

### Interlayer

The multilayer photoconductor of the present invention preferably has the interlayer 18 between the conductive support 11 and the photosensitive layer 14.

The interlayer has a function of preventing injection of charges from the conductive support to the multilayer photosensitive layer. That is, deterioration of the photosensitive layer in chargeability is inhibited and decrease of surface charges in a part other than that to be eliminated by exposure is limited, preventing generation of image defects such as fogging. In particular, it is possible to prevent fogging of images called black dots, that is, fine black dots of toner formed on a white background in image formation by a reverse developing process.

In addition, the interlayer that coats the surface of the conductive support can reduce the degree of unevenness, which is a defect of the surface of the conductive support, and even the surface to improve the coatability of the multilayer photosensitive layer, thereby improving adhesion between the conductive support and the photosensitive layer.

For example, the interlayer 18 can be formed by dissolving a resin material in an appropriate organic solvent to prepare a coating solution for interlayer formation, and applying the coating solution onto the surface of the conductive support, and then drying the same to remove the organic solvent.

Examples of the resin material include natural polymer materials such as casein, gelatin, polyvinyl alcohol and ethyl cellulose as well as the same binder resins as contained in the multilayer photosensitive layer, and one kind, or two or more kinds thereof may be used. Out of these resins, polyamide resins are preferable, and alcohol-soluble nylon resins are particularly preferable. Examples of the alcohol-soluble nylon resins include so-called copolyamides obtained by copolymerizing 6-nylon, 6,6-nylon, 6,10-nylon, 11-nylon, 2-nylon, 12-nylon, and the like; and resins obtained by chemically modifying nylon such as N-alkoxymethyl-modified nylon and N-alkoxyethyl-modified nylon.

Examples of the solvent in which the resin material is dissolved or dispersed include water; alcohols such as methanol, ethanol and butanol; glymes such as methyl carbitol and butyl carbitol; chlorine-based solvents such as dichloroethane, chloroform and trichloroethane; acetone; dioxolane; and mixed solvents obtained by mixing two or more of these solvents. Out of these solvents, non-halogen organic solvents are preferably used in consideration of a global environment.

Examples of the application method for the interlayer 18 include a spraying method, a bar coating method, a roll coating method, a blade method, a ring method, a dipping coating method, and the like. An optimal method can be appropriately selected from the above-mentioned application methods in consideration of the physical properties of the coating solution and productivity. In particular, the dipping coating method is relatively simple and advantageous in terms of productivity and costs, and therefore often used for the production of electrophotographic photoconductors. In the dipping coating method, the conductive support 11 is immersed in a coating vessel filled with the coating solution, and then raised at a constant rate or at a rate that changes successively to form a layer on the conductive support 11.

In addition, the coating solution for interlayer formation may contain metallic oxide particles.

The metallic oxide particles can easily adjust the volume resistivity of the interlayer to allow further prevention of the injection of charges to the multilayer photosensitive layer and maintenance of the electrical characteristics of the photoconductor under various environments.

Examples of the metallic oxide particles include titanium oxide, aluminum oxide, aluminum hydroxide and tin oxide particles.

When the total weight of the binder resin and the metallic oxide particles in the coating solution for interlayer formation is C, and the weight of the solvent is D, the ratio therebetween (C/D) is preferably 1/99 to 40/60, and particularly preferably 2/98 to 30/70.

In addition, when the weight of the binder resin is E, and the weight of the metallic oxide particles is F, the ratio therebetween (E/F) is preferably 90/10 to 1/99, and particularly preferably 70/30 to 5/95.

Though not particularly limited, the film thickness of the interlayer is preferably 0.01 μm to 20 μm, and particularly preferably 0.05 μm to 10 μm.

The film thickness of the interlayer of more than 20 μm may make it difficult to form an even interlayer and to form an even single-layer photosensitive layer on the interlayer, reducing the sensitivity of the photoconductor. On the other hand, the film thickness of the interlayer of less than 0.01 μm may cause the layer to fail in substantially functioning as an interlayer and in providing an even surface by coating the defect of the conductive support. That is, injection of charges from the conductive support to the multilayer photosensitive layer cannot be prevented, leading to deterioration in chargeability.

When the material for forming the conductive support is aluminum, a layer containing alumite (alumite layer) may be formed as an interlayer.

### Charge Generation Layer

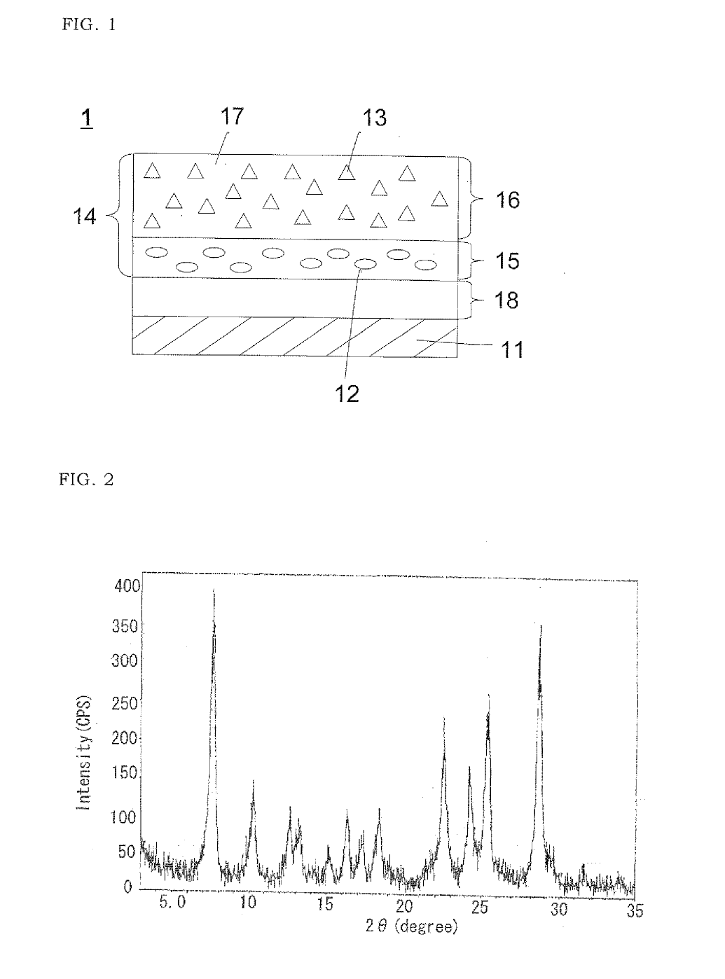

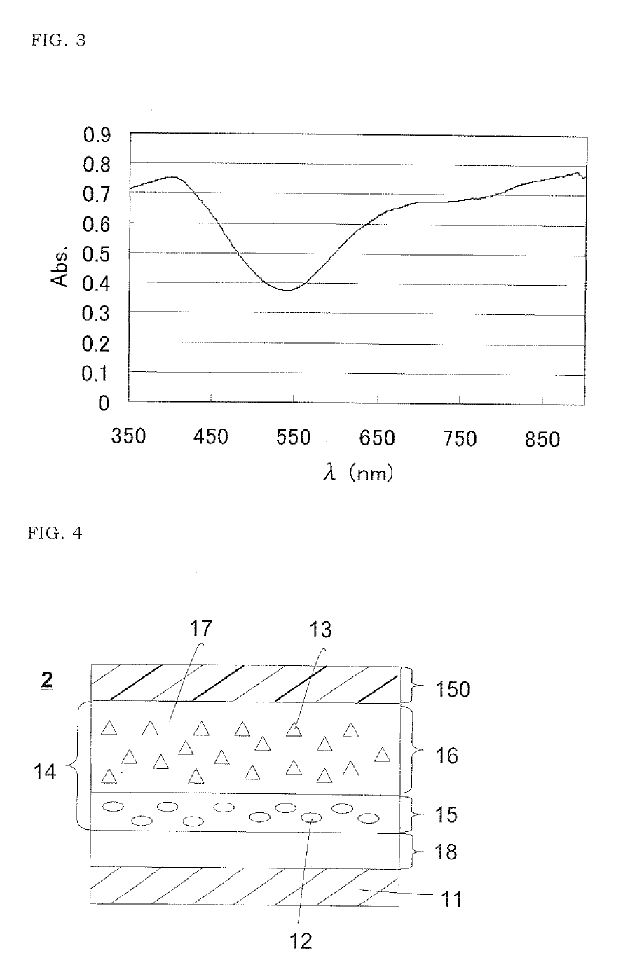

The charge generation layer 15 contains a titanylphthalocyanine as the charge generation material 12. Specific examples of the titanylphthalocyanine that is preferably used for the present invention include a titanylphthalocyanine having a crystal structure showing diffraction peaks (see FIG. 2, the vertical axis indicates the absorption intensity and the horizontal axis indicates the angle of diffraction) in an X-ray diffraction spectrum at Bragg angles (2θ±0.2°) of 7.5°, 12.3°, 16.3°, 25.3° and 28.7°.

The photoconductor containing the titanylphthalocyanine can provide images of high sensitivity and high quality even with exposure light having an oscillation wavelength in the wavelength range of 405±20 nm. In addition, the photoconductor is less dependent on humidity and excellent in environmental stability.

FIG. 3 shows a transmission and absorption spectrum of a titanylphthalocyanine having a crystal structure showing diffraction peaks in an X-ray diffraction spectrum at Bragg angles (2θ±0.2°) of 7.5°, 12.3°, 16.3°, 25.3° and 28.7° (the vertical axis indicates the absorption efficiency and the horizontal axis indicates the wavelength).

The sensitivity in the photoconductor is largely attributed to the light absorption efficiency of the charge generation material showing the above-described transmission and absorption spectrum. That is, FIG. 3 indicates that the above-described titanylphthalocyanine has an absorbance of approximately 0.75 at a wavelength of 405±20 nm in the transmission and absorption spectrum, and this is almost the same as the absorbance in a near-infrared region (approximately 780 nm), which is used as a conventional exposure light source.

Further, the above-described charge generation material has an absorption maximum around 405 nm and ensures an absorbance of approximately 0.7 or more in the wavelength region of 420 nm±20 nm, showing enough sensitivity following capability in response to shift of the oscillation wavelength due to thermal drift of the laser and allowing achievement of stable photoconductor performance.

The photoconductor of the present invention can therefore deliver highly sensitive and highly stable performance in an image forming apparatus including an exposure means with light having an exposure wavelength of 405±20 nm.

In addition, it is known that a titanylphthalocyanine pigment claimed in the present invention does not have water of crystallization, and therefore the photoconductor containing the titanylphthalocyanine as a charge generation material is less dependent on humidity and excellent in environmental stability.

For example, Japanese Unexamined Patent Publication No. SHO 61(1986)-239248 discloses a titanylphthalocyanine that is suitably used for the present invention and shows diffraction peaks in an X-ray diffraction spectrum at Bragg angles (2θ±0.2°) of 7.5°, 12.3°, 16.3°, 25.3° and 28.7°.

The charge generation material 12 may be used in combination with a sensitizing dye. Examples of the sensitizing dye include triphenylmethane type dyes such as Methyl Violet, Crystal Violet, Night Blue, and Victoria Blue; acridine dyes such as Erythrocin, Rhodamine B, Rhodamine 3R, Acridine Orange, and Flapeocine; thiazine dyes such as Methylene Blue and Methylene Green; oxazine dyes such as Capri Blue and Meldola's Blue; cyanine dyes; styryl dyes; pyrylium salt dyes; and thiopyrylium salt dyes.

Examples of the method for forming the charge generation layer 15 include a method in which the charge generation material 12 is vacuum deposited on the conductive support 11 and a method in which a coating solution for charge generation layer formation is prepared by dispersing the charge generation material 12 in a solvent and applied onto the conductive support 11. Out of these methods, preferable is a method in which the charge generation material 12 is dispersed by a conventionally known method in a binder resin solution prepared by mixing a binder resin as a binding agent in a solvent to obtain a coating solution and the obtained coating solution is applied onto the conductive support 11.

Hereinafter, this method will be described.

Examples of the binder resin include polyester resins, polystyrene resins, polyurethane resins, phenol resins, alkyd resins, melamine resins, epoxy resins, silicone resins, acrylic resins, methacrylate resins, polycarbonate resins, polyarylate resins, phenoxy resins, polyvinyl butyral resins, polyvinyl formal resins, and copolymer resins including two or more repeat units that form the above-mentioned resins. These resins may be used independently or in combination of two or more kinds thereof. Specific examples of the copolymer resins include insulating resins such as vinyl chloride/vinyl acetate copolymer resins, vinyl chloride/vinyl acetate/maleic anhydride copolymer resins and acrylonitrile/styrene copolymer resins. The binder resin is not limited to the above-mentioned resins, and any generally used resin may be used as the binder resin.

Examples of the solvent include halogenated hydrocarbons such as dichloromethane and dichloroethane; ketones such as acetone, methyl ethyl ketone and cyclohexanone; esters such as ethyl acetate and butyl acetate; ethers such as tetrahydrofuran (THF) and dioxane; alkyl ethers of ethylene glycol such as 1,2-dimethoxyethane, aromatic hydrocarbons such as benzene, toluene and xylene; and aprotic polar solvents such as N,N-dimethylformamide and N,N-dimethylacetamide. These solvents may be used independently or as a mixed solvent obtained by mixing two or more kinds thereof. In terms of global environmental consideration, it is preferable to use a non-halogen solvent.

The blending ratio between the charge generation material 12 and the binder resin is preferably set so that the percentage of the charge generation material 12 is in a range of 10% by weight to 99% by weight. The percentage of the charge generation material 12 of less than 10% by weight results in decrease in the sensitivity. The percentage of the charge generation material 12 of more than 99% by weight results not only in decrease in the film strength of the charge generation layer 15 but also in deterioration in the dispersibility of the charge generation material 12 to increase coarse particles, leading to increase in image defects, in particular, image fogging called black dots, which is a phenomenon that surface charges in a part other than that to be eliminated by exposure decrease to allow toner to adhere to a white background to form fine black dots.

Thus, the percentage of the charge generation material 12 is preferably in a range of 10% by weight to 99% by weight.

The charge generation material 12 may be milled in advance by use of a milling machine before dispersed in the binder resin solution. Examples of the milling machine include a ball mill, a sand mill, an attritor, an oscillation mill, an ultrasonic dispersing machine, and the like.

Examples of the dispersing machine to be used for dispersing the charge generation material 12 in the binder resin solution include a paint shaker, a ball mill, a sand mill, and the like. On this occasion, dispersion conditions are appropriately set so as to prevent contamination of the solution with impurities generated due to abrasion or the like of materials forming the container and the dispersing machine to use.

Examples of the application method for the coating solution for charge generation layer formation obtained by dispersing the charge generation material 12 in the binder resin solution include a spraying method, a bar coating method, a roll coating method, a blade method, a ring method, a dipping coating method, and the like. An optimal method can be selected from the above-mentioned application methods in consideration of the physical properties of the coating solution and productivity. In particular, the dipping coating method is relatively simple and advantageous in terms of productivity and costs, and therefore often used for the production of electrophotographic photoconductors. In the dipping coating method, the conductive support 11 is immersed in a coating vessel filled with the coating solution, and then raised at a constant rate or at a rate that changes successively to form a layer on the conductive support 11. The apparatus to be used for the dipping coating method may be provided with a coating solution disperser represented by an ultrasonic generator to stabilize the dispersibility of the coating solution.

The film thickness of the charge generation layer 15 is preferably in a range of 0.05 μm to 5 μm, and more preferably in a range of 0.1 μm to 1 μm. The film thickness of the charge generation layer 15 of less than 0.05 μm leads to reduction in the light absorption efficiency to reduce the sensitivity. The film thickness of the charge generation layer 15 of more than 5 μm causes the transfer of charges in the charge generation layer to be a rate-determining step in a process of eliminating charges on the surface of the photoconductor to reduce the sensitivity.

### Charge Transfer Layer

The charge transfer layer 16 is obtained by allowing the binder resin 17 to contain the charge transfer material 13 capable of receiving and transferring charges generated by the charge generation material 12. As the charge transfer material 13, a phenylenediamine compound represented by the general formula (I) of the present invention is used:

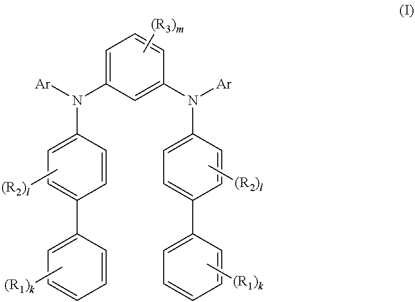

wherein Ar is an aryl group that may have a substituent, R₁, R₂ and R₃ are a hydrogen atom, a halogen atom, or an alkyl or alkoxy group, independently, R₃ is a hydrogen atom, a halogen atom, or an alkyl or alkoxy group that may have a substituent, k is an integer from 1 to 5, and l and m are an integer from 1 to 4.

For example, the phenylenediamine compound represented by the above-described general formula (I) can be produced as follows.

That is, a phenylenediamine derivative represented by the general formula (III):

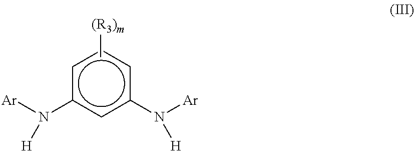

wherein Ar, R₃ and m are as defined in the general formula (I), is heated and stirred at 150° C. to 260° C. for 5 hours to 50 hours in the absence of solvent or in an organic solvent selected from nitrobenzene, dichlorobenzene, quinoline, N,N-dimethylformamide, N-methyl-2-pyrrolidone, and the like in the presence of: a halogenated biphenyl compound represented by the general formula (IV):

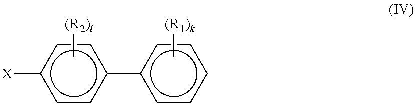

wherein R₁, R₂, k and l are as defined in the general formula (I); a copper catalyst selected from copper compounds such as copper powder, copper oxide and copper halide; and a basic compound selected from carbonates or hydroxides of an alkali metal such as potassium carbonate, sodium carbonate, potassium hydroxide and sodium hydroxide.

After completion of the reaction, the reaction mixture is cooled, the resulting product is dissolved in an organic solvent such as methylene chloride and toluene, the insoluble is separated, the solvent is distilled off, and then the residue is purified on an alumina column or a silica gel column and recrystallized from toluene, ethanol, ethyl acetate, or the like, thereby producing the phenylenediamine compound.

In addition, the phenylenediamine derivative, the halogenated biphenyl compound, the copper catalyst and the basic compound may be usually used in stoichiometric amounts in accordance with conventional methods, and preferably, the halogenated biphenyl compound may be used in a range of 2 mol to 10 mol, the copper catalyst may be used in a range of 0.1 mol to 2 mol, and the basic compound may be used in a range of 1 mol to 3 mol with respect to 1 mol of the phenylenediamine derivative. Examples of the phenylenediamine compound represented by the general formula (I) in the present invention include the following compounds:

TABLE 1
(I)

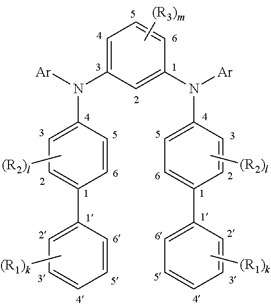

| Compound | R₁ | R₂ | R₃ | Ar |
|---|---|---|---|---|
| 1 | H | H | H | 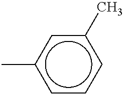 |
| 2 | H | H | H | 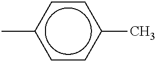 |
| 3 | H | H | H | 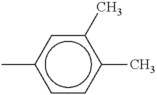 |
| 4 | H | H | H | 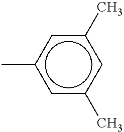 |
| 5 | H | H | H | 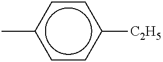 |
| 6 | H | H | H | 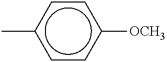 |
| 7 | H | H | H | 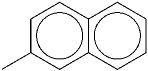 |
| 8 | H | H | H | 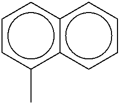 |
| 9 | H | H | H | 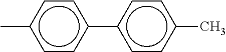 |
| 10 | H | H | H | 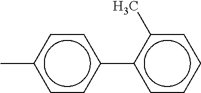 |
| 11 | H | H | H | 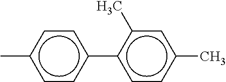 |
| 12 | 2′-CH₃ | H | H | 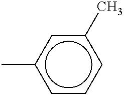 |
| 13 | 2′-CH₃ | H | H | 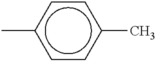 |
| 14 | 2′-CH₃ | H | H | 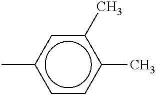 |
| 15 | 2′-CH₃ | H | H | 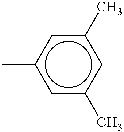 |
| 16 | 2′-CH₃ | H | H | 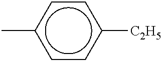 |
| 17 | 2′-CH₃ | H | H | 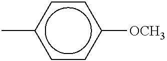 |
| 18 | 2′-CH₃ | H | H | 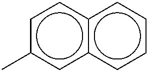 |
| 19 | 2′-CH₃ | H | H | 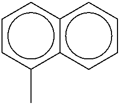 |
| 20 | 2′-CH₃ | H | H | 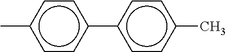 |
| 21 | 2′-CH₃ | H | H | 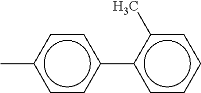 |
| 22 | 2′-CH₃ | H | H | 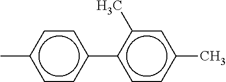 |
| 23 | 4′-CH₃ | H | H | 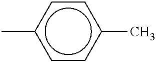 |
| 24 | H | 2-CH₃ | H | 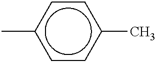 |
| 25 | 2′-CH₃ | 2-CH₃ | H | 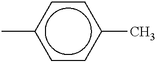 |
| 26 | H | H | 5-CH₃ | 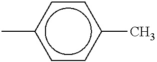 |
| 27 | 2′-CH₃ | H | 5-CH₃ | 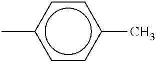 |

In addition, various kinds of other commonly known charge transfer materials may be mixed with the phenylenediamine compound of the present invention as long as the weight thereof in the total weight of the charge transfer materials in the charge transfer layer is 20% by weight or less. Examples thereof include carbazole derivatives, oxazole derivatives, oxadiazole derivatives, thiazole derivatives, thiadiazole derivatives, triazole derivatives, imidazole derivatives, imidazolone derivatives, imidazolidine derivatives, bisimidazolidine derivatives, styryl compounds, hydrazone compounds, polycyclic aromatic compounds, indole derivatives, pyrazoline derivatives, oxazolone derivatives, benzimidazole derivatives, quinazoline derivatives, benzofuran derivatives, acridine derivatives, phenazine derivatives, aminostilbene derivatives, triarylamine derivatives, triarylmethane derivatives, phenylenediamine derivatives, stilbene derivatives and benzidine derivatives. The examples further include polymers having groups derived from these compounds on the main chain or side chain such as poly-N-vinylcarbazole, poly-1-vinylpyrene, and poly-9-vinylanthracene.

As the binder resin 17 for the charge transfer layer 16, a resin having excellent compatibility with the charge transfer material 13 is selected. Specific examples thereof include polymethylmethacrylate resins, polystyrene resins, vinylpolymer resins such as polyvinyl chloride resins and their copolymer resins, polycarbonate resins, polyester resins, polyester carbonate resins, polysulfone resins, phenoxy resins, epoxy resins, silicone resins, polyarylate resins, polyamide resins, polyether resins, polyurethane resins, polyacrylamide resins and phenol resins. In addition, heat-curable resins obtained by partially cross-linking the above-mentioned resins may be used. These resins may be used independently or in combination of two or more kinds thereof. Out of the above-mentioned resins, polystyrene resins, polycarbonate resins, polyarylate resins and polyphenylene oxides are particularly preferably used for the binder resin 17, because they are excellent in coatability, potential characteristics, and the like as well as in electric insulation, having a volume resistivity of 10¹³Ω or more.

The charge transfer material 13 (A) and the binder resin 17 (B) are used at a ratio A/B of 10/12 to 10/30. When the ratio A/B is less than 10/30, that is, the proportion of the binder resin 17 is higher and when the charge transfer layer 16 is formed by a dipping coating method, the viscosity of the coating solution increases to cause reduction in application speed, leading to significantly low productivity. When the amount of the solvent in the coating solution is increased in order to restrict increase in the viscosity of the coating solution, a brushing phenomenon occurs and the charge transfer layer 16 formed becomes cloudy. On the other hand, when the ratio A/B is more than 10/12, that is, the proportion of the binder resin 17 is lower, printing durability is lower than that in the case where the proportion of the binder resin 17 is higher, leading to increase in the abrasion of the photosensitive layer.

As needed, the charge transfer layer 16 may contain an additive such as a plasticizer and a leveling agent in order to improve coatability, flexibility and surface smoothness. Examples of the plasticizer include dibasic acid esters, fatty acid esters, phosphoric esters, phthalate esters, chlorinated paraffins, and epoxy type plasticizers. Examples of the leveling agent include silicone type leveling agents and the like.

In addition, the charge transfer layer 16 may contain fine particles of an inorganic compound or an organic compound in order to improve mechanical strength and electrical characteristics.

As in the case of the formation of the above-described charge generation layer 15, for example, the charge transfer layer 16 is formed by dissolving or dispersing the charge transfer material 13 and the binder resin 17 and, as needed, an additive as mentioned above in an appropriate solvent to prepare a coating solution for charge transfer layer formation, and applying the coating solution onto the charge generation layer 15 by a spraying method, a bar coating method, a roll coating method, a blade method, a ring method, a dipping coating method, or the like. Out of these application methods, in particular, the dipping coating method is often used also for the formation of the charge transfer layer 16, because it is excellent in various points as described above.

The solvent to be used for the coating solution is selected from the group consisting of: aromatic hydrocarbons such as benzene, toluene, xylene and monochlorobenzene; halogenated hydrocarbons such as dichloromethane and dichloroethane; ethers such as THF, dioxane and dimethoxymethyl ether; aprotic polar solvents such as N,N-dimethylformamide; and the like. These solvents are used independently or in combination of two or more kinds thereof. As needed, a solvent such as alcohols, acetonitrile and methyl ethyl ketone may be further added to the solvent. In addition, non-halogen organic solvents are preferably used in terms of global environmental consideration.

The thickness of the charge transfer layer 16 is preferably in a range of 5 μm to 50 μm, and more preferably 10 μm to 40 μm. The film thickness of the charge transfer layer 16 of less than 5 μm leads to deterioration in the charge retention ability on the surface of the photoconductor. The film thickness of the charge transfer layer 16 of more than 50μ leads to decrease in the resolution of the photoconductor.

In order to improve the sensitivity and prevent increase in residual potential and fatigue due to repeated use, one or more kinds of electron acceptor substances and dyes may be further added to the photosensitive layer 14.

Examples of the electron acceptor substances include acid anhydrides such as succinic anhydride, maleic anhydride, phthalic anhydride and 4-chloronaphthalic acid anhydride; cyano compounds such as tetracyanoethylene and terephthalmalondinitrile; aldehydes such as 4-nitrobenzaldehyde; anthraquinones such as anthraquinone and 1-nitroanthraquinone; polycyclic or heterocyclic nitro compounds such as 2,4,7-trinitrofluorenone and 2,4,5,7-tetranitrofluorenone; electron attractive materials such as diphenoquinone compounds; compounds obtained by polymerizing these electron attractive materials; and the like.

Examples of the dyes include xanthene type dyes, thiazine dyes, triphenylmethane dyes, quinoline type pigments and organic photoconductive compounds such as copper phthalocyanine. These organic photoconductive compounds function as an optical sensitizer.

FIG. 4 is a schematic cross sectional view simplistically illustrating a structure of an electrophotographic photoconductor 2 as another example of the electrophotographic photoconductor of the present invention. The electrophotographic photoconductor 2 resembles the electrophotographic photoconductor 1 illustrated in FIG. 1, and corresponding components will be denoted by the same reference numerals and description thereof will be omitted.

It should be noted that the electrophotographic photoconductor 2 has a surface protective layer 150 provided on the outermost layer of the electrophotographic photoconductor 1.

Examples of binder resins that are effectively used for the surface protective layer 150 include polystyrene, polyacetal, polyethylene, polycarbonate, polyarylate, polysulfone, polypropylene, polyvinyl chloride, and the like. Considering abrasion resistance and electrical characteristics, polycarbonate and polyarylate are preferable. These binders may be used independently or in combination of two or more kinds thereof.

Furthermore, in order to improve the abrasion resistance, a filler material may be added to the surface protective layer 150 of the photoconductor. Examples of the filler material include organic filler materials and inorganic filler materials. Examples of the organic filler materials include fluororesin powders such as polytetrafluoroethylene, silicone resin powders, a-carbon powders, and the like. Examples of the inorganic filler materials include powders of metals such as copper, tin, aluminum and indium; metal oxides such as silica, tin oxide, zinc oxide, titanium oxide, indium oxide, antimony oxide, bismuth oxide, tin oxide doped with antimony and indium oxide doped with tin; potassium titanate; and the like.

Out of the above-mentioned materials, in particular, it is advantageous to use an inorganic material in terms of the hardness of the filler. The average primary particle diameter of the filler is preferably 0.01 μm to 0.5 μm in terms of the light transmittance and the abrasion resistance of the surface protective layer. The filler may be surface-treated with an inorganic material or an organic material in order to improve its dispersibility. Generally known examples of the surface treatment include water-repellent treatments using a silane coupling agent, a fluorine type silane coupling agent or a high fatty acid; and treatments with inorganic materials in which the surface of the filler is treated with alumina, zirconia, tin oxide or silica.

The higher the concentration of the filler material in the surface protective layer is, the higher the abrasion resistance preferably is. However, too high concentration may cause increase in residual potential and decrease in writing light transmittance of the protective layer, bringing about an adverse effect. The concentration of the filler material is therefore approximately 50% by weight or less, and preferably approximately 30% by weight or less with respect to the total solid of the surface protective layer. In addition, the surface protective layer may contain the charge transfer material 13.

Appropriately, the thickness of the surface protective layer 150 is approximately 0.1 μm to 10 μm. Preferably, it is in a range of 1.0 μm to 8.0 μm. The photoconductor to be used repeatedly for a long term should have high mechanical durability and high abrasion resistance. However, in an actual machine, ozone, NOx gas, and the like are generated from a charged member and adhere to the surface of the photoconductor to cause image flow. In order to prevent the image flow, it is necessary to abrade the photoconductor at a rate more than a certain level. Accordingly, the film thickness of the surface protective layer is preferably at least 1.0 μm in consideration of repeated use for a long term. On the other hand, the film thickness of the surface protective layer of more than 8.0 μm may cause increase in residual potential and deterioration in reproducibility of fine dots.

An electrophotographic device of the present invention comprises: the multilayer photoconductor of the present invention; a charge means for charging the multilayer photoconductor; an exposure means for exposing the charged multilayer photoconductor with a blue laser diode; and a development means for developing an electrostatic latent image to be formed by exposure.

Hereinafter, the image forming apparatus and operation thereof of the present invention will be described with reference to the drawings; however, they are not limited to the following description.

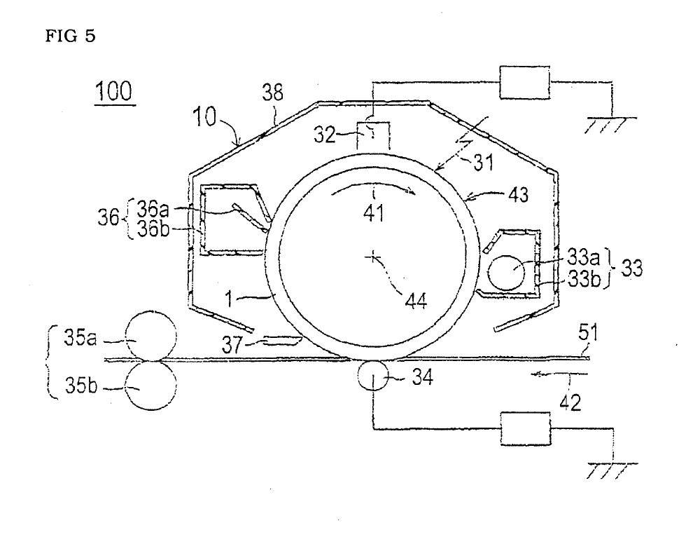

An image forming apparatus (laser printer) 100 in FIG. 5 includes the multilayer photoconductor 1 of the present invention (see FIG. 1), an exposure means (semiconductor laser) 31, a charge means (corona charger) 32, a development means (developing device) 33, a transfer means (transfer charger) 34, a transport belt (not shown), a fixing means (fixing device) 35 and a cleaning means (cleaner) 36. The reference numeral 51 denotes a transfer paper.

The multilayer photoconductor 1 is supported by a main body, not shown, of the image forming apparatus 100 in a freely rotatable manner and rotationally driven in a direction of an arrow 41 by a driving means, not shown, around a rotation axis 44. The driving means includes an electric motor and reduction gears, for example, and transmits its driving force to the conductive support that forms a core body of the multilayer photoconductor 1, thereby rotationally driving the multilayer photoconductor 1 at a predetermined peripheral speed.

The charger 32, the exposure means 31, the developing device 33, the transfer charger 34 and the cleaner 36 are provided in this order along a peripheral surface of the multilayer photoconductor 1 from an upstream side toward a downstream side in a rotation direction denoted by the arrow 41 of the multilayer photoconductor 1.

The charger 32 is a charge means for uniformly charging the peripheral surface of the multilayer photoconductor 1 to a predetermined potential.

The exposure means 31 includes a blue semiconductor laser beam as a light source and exposes the peripheral surface of the charged multilayer photoconductor 1 according to image information by applying a laser beam output from the light source to the surface of the multilayer photoconductor 1 between the charger 32 and the developing device 33. The light is scanned repeatedly in a main scanning direction, that is, a direction to which the rotation axis 44 of the multilayer photoconductor 1 extends, to be imaged to sequentially form electrostatic latent images on the surface of the multilayer photoconductor 1. Specifically, the electrostatic latent images are formed by a difference between the amount of charges where the laser beam is applied and the amount of charges where the laser beam is not applied in the multilayer photoconductor 1 uniformly charged by the charger 32.

The developing device 33 is a development means for developing an electrostatic latent image formed by exposure on the surface of the multilayer photoconductor 1 with a developer (toner), and it is provided so as to face the multilayer photoconductor 1. The developing device 33 includes a developing roller 33a for supplying the toner to the peripheral surface of the multilayer photoconductor 1 and a case 33b that rotatably supports the developing roller 33a around a rotation axis parallel to the rotation axis 44 of the multilayer photoconductor 1 and contains the developer including the toner in its internal space.

The transfer charger 34 is a transfer means for transferring a toner image, which is a visible image to be formed on the peripheral surface of the multilayer photoconductor 1 as a result of the development onto the transfer paper 51, which is a recording medium supplied between the multilayer photoconductor 1 and the transfer charger 34 in a direction of an arrow 42 by a transport means, not shown. For example, the transfer charger 34 is a non-contact type transfer means that includes a charge means and transfers a toner image onto the transfer paper 51 by giving the transfer paper 51 charges of a polarity reverse to that of the toner.

The cleaner 36 is a cleaning means that removes and collects toner remaining on the peripheral surface of the multilayer photoconductor 1 after the operation of transfer by the transfer charger 34, and it includes a cleaning blade 36a for peeling off the toner remaining on the peripheral surface of the multilayer photoconductor 1 and a collection case 36b for containing the toner peeled off by the cleaning blade 36a. In addition, the cleaner 36 is provided along with a discharge lamp, not shown.

The image forming apparatus 100 is further provided with the fixing device 35 at a downstream side of the direction in which the transfer paper 51 is transported after passing between the multilayer photoconductor 1 and the transfer charger 34. The fixing device 35 is a fixing means for fixing a transferred image. The fixing device 35 includes a heat roller 35a having a heating means, not shown, and a pressure roller 35b provided opposite the heat roller 35a so as to be pressed by the heat roller 35a to form an abutment.

Furthermore, the reference numeral 37 denotes a separation means for separating the transfer paper from the photoconductor, and the reference numeral 38 denotes a housing (case) for containing the devices for the image formation process.

Operation of image formation by the image forming apparatus 100 is carried out as follows. First, the multilayer photoconductor 1 is rotationally driven by the driving means in the direction of the arrow 41, and then the surface of the multilayer photoconductor 1 is uniformly charged to a predetermined positive potential by the charger 32 provided at an upstream side of the rotation direction of the multilayer photoconductor 1 with respect to an image formation point of the light applied by the exposure means 31.

Subsequently, the exposure means 31 irradiates the surface of the multilayer photoconductor 1 with light according to image information. In the multilayer photoconductor 1, the surface charge of the irradiated part is eliminated by this exposure to make a difference between the surface potential of the irradiated part and the surface potential of the non-irradiated part, thereby forming an electrostatic latent image.

The developing device 33 provided at a downstream side of the rotation direction of the multilayer photoconductor 1 with respect to the image formation point of the light from the exposure means 31 supplies toner to the surface of the multilayer photoconductor 1 on which the electrostatic latent image has been formed to develop the electrostatic latent image, thereby forming a toner image.

In synchronization with the exposure for the multilayer photoconductor 1, the transfer paper 51 is fed between the multilayer photoconductor 1 and the transfer charger 34. The transfer charger 34 gives the fed transfer paper 51 charges of a polarity reverse to that of the toner, and the toner image formed on the surface of the multilayer photoconductor 1 is transferred onto the transfer paper 51.

The transfer paper 51 on which the toner image has been transferred is transported to the fixing device 35 by the transport means, and heated and pressurized when passing through the abutment between the heat roller 35a and the pressure roller 35b of the fixing device 35. As a result, the toner image is fixed onto the transfer paper 51 to be a solid image. The transfer paper 51 on which the image has been thus formed is ejected to the outside of the image forming apparatus 100 by the transport means.

Meanwhile, the toner remaining on the surface of the multilayer photoconductor 1 even after the transfer of the toner image by the transfer charger 34 is peeled off the surface of the multilayer photoconductor 1 and collected by the cleaner 36. The charges on the surface of the multilayer photoconductor 1 from which the toner has been thus removed is eliminated by the action of light applied from the discharge lamp to eliminate the electrostatic latent image on the surface of the multilayer photoconductor 1. Thereafter, the multilayer photoconductor 1 is further rotationally driven, and a series of operations beginning with the charge is repeated again to form images continuously.

Hereinafter, the present invention will be described in detail by way of examples and comparative examples; however, the present invention is not limited to these examples.

The phenylenediamine compounds prepared in the following production examples were evaluated by measurement for an NMR spectrum with a ¹H-NMR measurement apparatus and under measurement conditions to be mentioned below.

Measurement apparatus: Mercury-300 spectrometer (300 MHz, product by Varian)

Measurement solvent: CDCl₃

Sample concentration: approximately 4 mg of sample/0.4 m (CDCl₃)

### Production Example 1

### Preparation of Compound 2

In 100 ml of o-dichlorobenzene, 5.0 g (1.0 equivalent) of Compound (B) represented by the following formula:

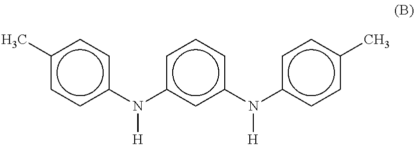

11.7 g (2.1 equivalents) of Compound (C) represented by the following formula:

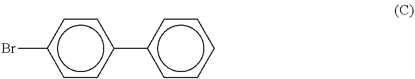

2.2 g (2.0 equivalents) of copper powder and 19.1 g (8.0 equivalents) of anhydrous potassium carbonate were mixed, and the reaction temperature was raised to 180° C. The mixture was stirred and refluxed for 18 hours for reaction under heating to maintain this temperature. After completion of the reaction, hot filtration through celite was performed, the filtrate was concentrated, and the residue was purified by silica gel column chromatography (developing solvent: toluene/ethyl acetate=1/1) to obtain 6.0 g of a white powdery compound.

The obtained white powdery compound was measured for the ¹H-NMR spectrum and analyzed for the chemical structure. As a result, the ¹H-NMR spectrum showed δ 2.31 (s, 6H), 6.68 (dd, J=8.1 Hz, J=2.4, 2H), 6.88 (t, J=2.1 Hz, 1H), 7.00-7.13 (m, 13H), 7.27-7.32 (m, 2H), 7.34-7.44 (m, 8H), 7.47-7.54 (m, 4H) to confirm that Compound 2 was a phenylenediamine compound having a structure represented by the following formula:

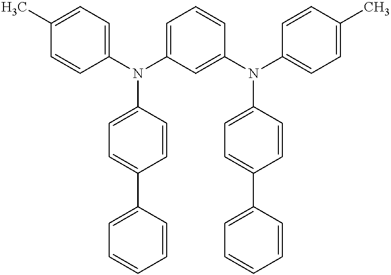

### Production Example 2

### Production of Compound 13

An objective compound in an amount of 6.2 g was obtained in the same manner as in Production Example 1 except that Compound (C) in the Production Example 1 was changed to Compound (E) represented by the following formula:

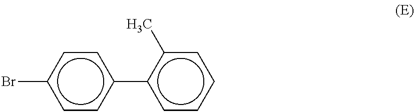

The analysis for the chemical structure was carried out in the same manner as in Production Example 1, too.

The ¹H-NMR spectrum showed δ 2.23 (s, 6H), 2.30 (s, 6H), 6.68 (dd, J=8.1 Hz, J=2.1 Hz, 2H), 6.92 (t, J=2.4 Hz, 1H), 7.03-7.30 (m, 25H) to confirm that Compound 13 was a phenylenediamine compound represented by the following formula:

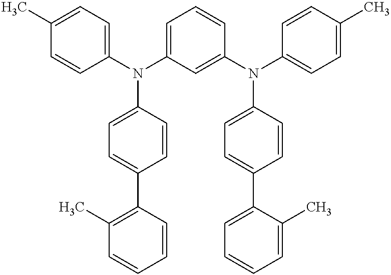

### Production Example 3

### Preparation of Compound 21

A product was obtained in the same manner as in Production Example 2 except that Compound (B) in Production Example 1 was changed to Compound (F) represented by the following formula:

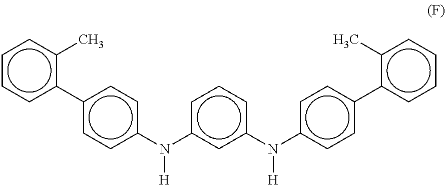

The analysis for the chemical structure was carried out in the same manner as in Production Example 1, too.

The ¹H-NMR spectrum showed δ 2.27 (s, 12H), 6.82 (dd, J=7.8 Hz, J=2.1 Hz, 2H), 7.07 (t, J=2.1 Hz, 1H), 7.15-7.26 (m, 33H) to confirm that Compound 21 was a phenylenediamine compound represented by the following formula:

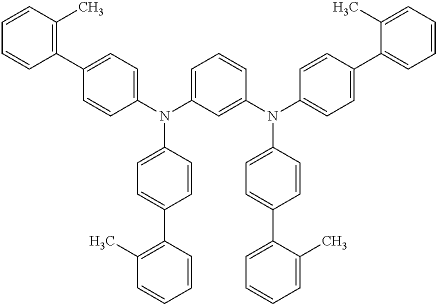

### Example 1

A titanium oxide (trade name: TIPAQUE TTO-D-1, product by ISHIHARA SANGYO KAISHA, LTD.) in an amount of 3 parts by weight and a commercially available polyimide resin (trade name: Amilan CM8000, product by Toray Industries, Inc.) in an amount of 2 parts by weight were added to methyl alcohol in an amount of 25 parts by weight and dispersed with the use of a paint shaker for 8 hours to prepare 3 kg of a coating solution for interlayer formation. A drum-like aluminum support having a diameter of 30 mm and a length of 357 mm as a conductive support was immersed in a coating vessel filled with the obtained coating solution for interlayer formation, and then raised to form an interlayer having a film thickness of 1 μm.

Subsequently, the charge generation material was produced by the following method.

In a 2-liter separable flask, 100 g (0.780 mol) of o-phthalonitrile and 1 L of quinoline were set and stirred under a nitrogen atmosphere, and 84.98 g (0.448 mol) of titanium tetrachloride was added thereto. Thereafter, the temperature was raised up to 180° C., and the mixture was stirred under heating at the temperature for 6 hours. When the temperature in the system fell to 150° C. after completion of the reaction, hot filtration was performed and washing was performed with 1 L of hot DMF (110° C.).

The wet cake obtained was added to 640 mL of DMF, dispersed at 130° C. for 2 hours, filtered off hot at this temperature and washed with 1 L of DMF. This process was repeated four times, and then washing was performed by sprinkling 1 L of methanol. The wet cake obtained was dried under vacuum at 40° C. to obtain a blue solid. Yield: 86.3 g, 76.8%.

Next, 900 g of concentrated sulfuric acid was cooled to 3° C. or less in an ice-methanol bath, and 30 g (52 mmol) of the blue solid obtained as described above was put therein at a temperature maintained at 5° C. or less. After stirring for 1 hour at 5° C. or less, the reaction mixture was added dropwise to 9000 mL of water and 1000 mL of ice at a temperature maintained so as not to exceed 5° C., and then dispersed for 2 hours at room temperature, allowed to stand, and filtered. The cake obtained was added to 6000 mL of water, dispersed for 1 hour at room temperature, and then allowed to stand and filtered. The above-described process was repeated three times. The cake obtained was added to 5000 mL of water, dispersed for 1 hour at room temperature, and then allowed to stand and filtered.

Further, the above-described process was repeated twice, and then the wet cake was washed with 2000 mL of ion-exchange water and collected when it satisfied the condition of pH>6.0 and electric conductivity <20 μS. The wet cake was dried and milled to obtain 26.0 g of a blue solid.

The blue solid obtained was measured for an X-ray diffraction spectrum to be confirmed as a titanylphthalocyanine of a crystal form having peaks in an X-ray diffraction spectrum for CuK□ rays at Bragg angles (2θ±0.2°) of 7.5°, 12.3°, 16.3°, 25.3° and 28.7° (Titanylphthalocyanine A).

Then, 1.8 parts by weight of the titanylphthalocyanine obtained here, 1.2 parts by weight of a butyral resin (S-LEC BX-1, product by SEKISUI CHEMICAL CO., LTD.), 87.3 parts by weight of dimethoxyethane, and 9.7 parts by weight of cyclohexanone were mixed (mixing ratio=90/10) and dispersed with the use of a paint shaker to prepare 3 kg of a coating solution for charge generation layer formation. This coating solution was applied onto the above-described interlayer in the same dipping coating method as in the case of the interlayer and air dried to form a charge generation layer having a film thickness of 0.3 μm.

Subsequently, 2100 parts by weight of each compound shown in Table 1 as a charge transfer material, 160 parts by weight of a polycarbonate resin (TS2050, product by TEIJIN CHEMICALS LTD.), and 0.02 parts by weight of a silicone oil (SH200, product by Dow Corning Toray) were mixed and added to tetrahydrofuran as a solvent to prepare 3 kg of a coating solution for charge transfer layer formation having a solid content of 21% by weight. The coating solution for charge transfer layer formation was applied onto the surface of the charge generation layer prepared in advance by a coating method with an applicator and by a dipping method, and dried at 120° C. for 1 hour to form a charge transfer layer having a film thickness of 28 μm. Thus, the multilayer photoconductor illustrated in FIG. 1 was produced.

### Example 2

A multilayer photoconductor was produced in the same manner as in Example 1 except that Compound 13 as described above was used instead of Compound 2 in Example 1.

### Example 3

A multilayer photoconductor was produced in the same manner as in Example 1 except that Compound 21 as described above was used instead of Compound 2 in Example 1.

### Comparative Example 1

A multilayer photoconductor as illustrated in FIG. 1 was produced in the same manner as in Example 1 except that a triphenylamine compound (TPD) (trade name: D2448, product by Tokyo Chemical Industry Co., Ltd.) represented by the following formula was used instead of Compound 2 in Example 1.

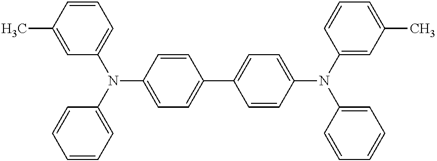

### Comparative Example 2

A multilayer photoconductor as illustrated in FIG. 1 was produced in the same manner as in Example 1 except that an enamine compound (synthesized by a method disclosed in Japanese Patent No. 3881651) represented by the following formula was used instead of Compound 2 in Example 1.

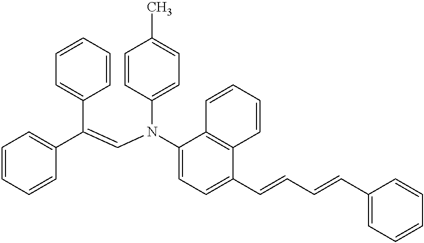

### Comparative Example 3

A multilayer photoconductor as illustrated in FIG. 1 was produced in the same manner as in Example 1 except that a triphenylamine compound (trade name: D2558, product by Tokyo Chemical Industry Co., Ltd.) represented by the following formula was used instead of Compound 2 in Example 1.

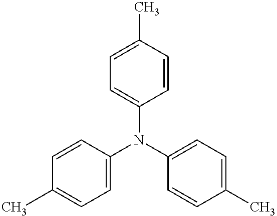

### Comparative Example 4

A photoconductor was produced in the same manner as in Example 1 except that a titanylphthalocyanine that was obtained in accordance with a production example disclosed in Japanese Unexamined Patent Publication No. 2000-105479 and that has a crystal showing a strong peak in an X-ray diffraction spectrum at a Bragg angle (20θ±0.2°) of 27.2° (Titanylphthalocyanine B) was used as a charge generation material.

### Comparative Example 5

A photoconductor was produced in the same manner as in Example 1 except that a specific titanylphthalocyanine that was obtained in accordance with a production example disclosed in Japanese Unexamined Patent Publication No. HEI 11(1999)-80161 (Titanylphthalocyanine C) was used as a charge generation material.

### Evaluation

1. Each of the photoconductors obtained in Examples 1 to 3 and Comparative Examples 1 to 5 was mounted in a test copying machine obtained by modifying a digital copying machine of a negative charge system having a resolution of 1200 dpi (trade name: MX-2600, product by Sharp Corporation) so that the exposure unit (LSU) thereof is adapted to use with a blue semiconductor laser (405 nm), and the photoconductor was evaluated for electrical characteristics and environmental stability with a TReK (model 344, product by TREK JAPAN) provided for measurement for the surface potential of the photoconductor in the image formation process.

First, as the charge potential V0 (V), each photoconductor was measured for the surface potential immediately after the charge operation by the charger under an N/N (normal temperature/normal humidity) environment of a temperature of 25° C. and a relative humidity of 50%. As the residual potential VL (V), each photoconductor was measured for the surface potential immediately after exposure with a laser beam (wavelength: 405 nm) under the N/N environment. In addition, image evaluation for an initial image was performed. Specifically, the evaluation was performed on a 1-line image, a horizontal and vertical 2-line image, a black solid 1-line-missing image, and a 1 dot-by-1 dot (1 dot printed every 1 dot) image in a self-printing mode in a monochrome mode.

Next, the measurement for the charge potential V0 (V) and the residual potential VL (V), and the image evaluation for an initial image were performed also under an N/L (normal temperature/low humidity) environment of a temperature of 25° C. and a relative humidity of 5% in the same manner as under the N/N environment.

Furthermore, each photoconductor was measured for the surface potential immediately after the charge operation as the charge potential V0 (V) and for the surface potential after the exposure as the residual potential VL (V), after a test image having a predetermined pattern (character test chart provided in ISO 19752) was successively copied onto 100000 sheets of recording paper under the N/L environment of a temperature of 25° C. and a relative humidity of S % in the same manner as for the initial images. In addition, image evaluation was performed on an image after being copied onto 100000 sheets of recording paper.

2. Each of the coating solutions for charge transfer layer formation used in Examples and Comparative Examples was applied onto a polyethylene terephthalate (abbreviated as PET) film having a thickness of 100 μm with an applicator and dried with 120° C. hot air for 60 minutes to produce a charge transfer layer having a film thickness of 20 μm. This film was determined for the light transmittance at a wavelength of 405 nm in a unit of % with a model U-4000 spectrophotometer (product by Hitachi, Ltd.)

The following table shows the evaluation results.

TABLE 2

| | | | | N/N | | | N/L | | | N/L | | |
|---|---|---|---|---|---|---|---|---|---|---|---|---|
| | | | Trans- | Initial | | | Initial | | | Fatigue | | |
| | Charge | Charge | mit- | stage | | | stage | | | property | | |
| | generation | transfer | tance | V₀ | VL | Image | V₀ | VL | Image | V₀ | VL | Image |
| | material | material | (%) | (V) | (V) | property | (V) | (V) | property | (V) | (V) | property |
| Example 1 | Titanylphthal- | Compound 2 | 98 | 602 | 81 | Excellent | 602 | 101 | Excellent | 589 | 112 | Excellent |
| | ocyanine A | | | | | | | | | | | |
| Example 2 | Titanylphthal- | Compound 13 | 96 | 601 | 78 | Excellent | 603 | 105 | Excellent | 590 | 115 | Excellent |
| | ocyanine A | | | | | | | | | | | |
| Example 3 | Titanylphthal- | Compound 21 | 100 | 605 | 85 | Excellent | 604 | 110 | Excellent | 592 | 118 | Excellent |
| | ocyanine A | | | | | | | | | | | |
| Comparative | Titanylphthal- | TPD | 48.5 | 604 | 230 | Unclear | 609 | 261 | Unclear | 550 | 280 | Low density |
| Example 1 | ocyanine A | | | | | | | | | | | Unclear |
| | | | | | | | | | | | | Fogging |
| Comparative | Titanylphthal- | Enamine | 0 | 607 | 290 | Low density | 608 | 310 | Low density | 553 | 322 | Low density |
| Example 2 | ocyanine A | | | | | Unclear | | | Unclear | | | Unevaluable |
| | | | | | | | | | | | | Fogging |
| Comparative | Titanylphthal- | Triphenyl- | 100 | 610 | 305 | Low density | 610 | 355 | Low density | 560 | 370 | Low density |
| Example 3 | ocyanine A | amine | | | | Unevaluable | | | Unevaluable | | | Unevaluable |
| | | | | | | | | | | | | Fogging |
| Comparative | Titanylphthal- | Compound 2 | 98 | 602 | 86 | Excellent | 605 | 110 | Excellent | 510 | 180 | Low density |
| Example 4 | ocyanine B | | | | | | | | | | | Fogging |
| Comparative | Titanylphthal- | Compound 2 | 98 | 604 | 89 | Excellent | 606 | 160 | Low density | 505 | 223 | Low density |
| Example 5 | ocyanine C | | | | | | | | | | | |

Examples 1 to 3 and Comparative Examples 1 to 3 have revealed that the electrophotographic photoconductors using a phenylenediamine compound of the present invention as a charge transfer material have higher sensitivity and higher transmittance in the charge transfer layer. It has been also revealed that it is possible to achieve an image forming apparatus that can fully exploit advantages of the optical system owing to a shorter wavelength employed for the exposure light source even in an attempt to attain higher resolution by using a phenylenediamine compound of the present invention.

It has been further revealed that the triphenylamine (TPD) compound of Comparative Example 1 and the enamine compound of Comparative Example 2 have low transmittance to prevent sufficient light from reaching the charge generation layer, leading to poor sensitivity. In addition, with these compounds, light was absorbed in the charge transfer material to cause light emission in the charge transfer layer, and images were evaluated to be unclear. Though having excellent transmittance, the triphenylamine compound of Comparative Example 3 showed very low sensitivity due to a problem with the charge transfer function and therefore gave an image density at an unevaluable level.

Furthermore, Comparative Examples 1 to 5 have revealed that use of a combination of a charge generation material and a charge transfer material that are different from those of the present invention leads to significant deterioration in the initial charge due to repeated use under a low-humidity environment to observe fogging in the image evaluation.

In particular, the tendency was significant when the specific charge generation materials of Comparative Examples 4 and 5 were used. This is inferred due to difference in crystal structure and difference in process of forming charge trapping owing to the difference in crystal structure. In Examples 1 to 3, on the other hand, deterioration in the initial charge due to repeated use under a low-humidity environment is inhibited to maintain an excellent state in the image evaluation. Thus, it has been revealed that the phenylenediamine of the present invention and the titanylphthalocyanine having a specific crystal form of the present invention are unable to produce an effect independently but are effective for improvement of the environmental stability when in combination.

It is possible to provide an electrophotographic photoconductor and an electrophotographic device having high stability even under a low-humidity circumstance, high sensitivity and high resolution by including the phenylenediamine compound represented by the general formula (I) as a charge transfer material and including the titanylphthalocyanine having a specific crystal structure as a charge generation material in an electrophotographic photoconductor that is used with an exposure light source having a wavelength of 405±20 nm.

1. An electrophotographic photoconductor that is usable in an exposure light source having a wavelength of 405±20 nm, the electrophotographic photoconductor comprising a photosensitive layer including a charge generation layer and a charge transfer layer stacked in order on a conductive substrate,
the charge transfer layer containing, as a charge transfer material, a phenylenediamine compound represented by the following general formula (I): 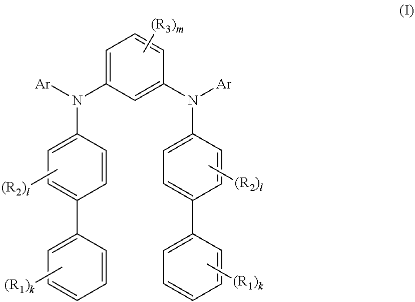
wherein Ar is an aryl group that may have a substituent, R₁, R₂ and R₃ are a hydrogen atom, a halogen atom, or an alkyl or alkoxy group, independently, R₃ is a hydrogen atom, a halogen atom, or an alkyl or alkoxy group that may have a substituent, k is an integer from 1 to 5, and l and m are an integer from 1 to 4,
the charge generation layer containing, as a charge generation material, a titanylphthalocyanine having a crystal form showing diffraction peaks in an X-ray diffraction spectrum at Bragg angles (2θ±0.2°) of 7.5°, 12.3°, 16.3°, 25.3° and 28.7°.

2. The electrophotographic photoconductor according to claim 1, wherein in the general formula (I), the aryl group represented by Ar is a phenyl, naphthyl or biphenyl group; the substituent that the aryl group may have is a C₁₋₄ alkyl or alkoxy group; the halogen atom represented by R₁, R₂ and R₃ is a fluorine, chlorine, bromine or iodine atom; and the alkyl or alkoxy group represented by R₁, R₂ and R₃ are a C₁₋₄ alkyl or alkoxy group.

3. The electrophotographic photoconductor according to claim 1, wherein the compound of the general formula (I) contains hydrogen atoms as R₂ and R₃, and is a phenylenediamine compound represented by the following general formula (II): 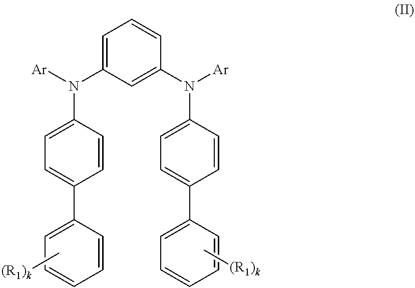
wherein Ar, R₁ and k are as defined in the general formula (I).

4. The electrophotographic photoconductor according to claim 1, wherein the compound of the general formula (I) contains a 4-methylphenyl or 2′-methyl-4-biphenylyl group as Ar, a hydrogen atom or a 2′-methyl group as R₁, and hydrogen atoms as R₂ and R₃, and is a phenylenediamine compound represented by the following formulae:

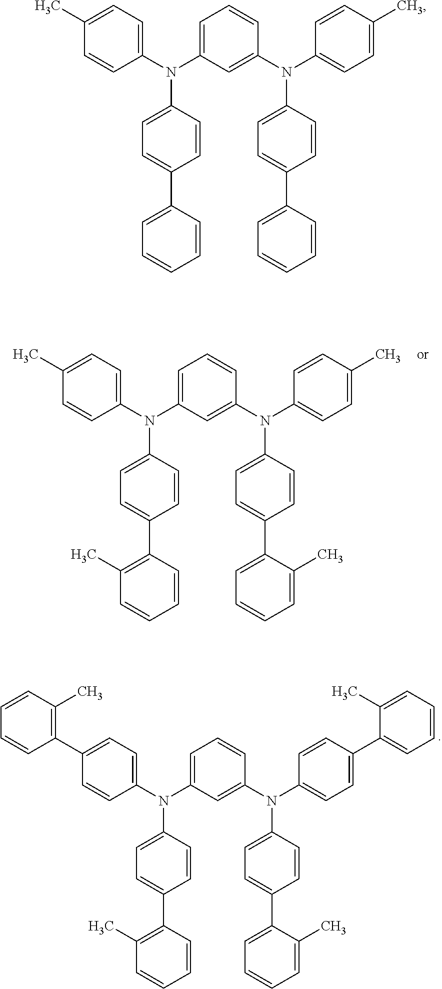

5. The electrophotographic photoconductor according to claim 1, wherein the conductive substrate and the photosensitive layer have an interlayer therebetween.

6. An image forming apparatus comprising:
the electrophotographic photoconductor according to claim 1;
a charge means for charging the electrophotographic photoconductor;
a light source having a wavelength of 405±20 nm as an exposure means for exposing the charged electrophotographic photoconductor; and
a development means for developing an electrostatic latent image to be formed by exposure.

7. The image forming apparatus according to claim 6, wherein the exposure means is a blue-violet semiconductor laser.
